(19) United States
(12) Patent Application Publication
(10) Pub. No.: US 2002/0080560 A1
(43) Pub. Date: Jun. 27, 2002

(54) Housing for electronic device

(76) Inventor: Arnaud Flegeo, Challes (FR)

Correspondence Address: Philips Electronics North America Corporation, 580 White Plains Road, Tarrytown, NY, 10591, US

(21) Appl. No.: 10/015,843

(22) Filed: Dec. 10, 2001

(30) Foreign Application Priority Data
Dec. 12, 2000 (FR) 0016165

(51) Int. Cl. H02B 1/00

(52) U.S. Cl. 361/600; 361/679

(57) ABSTRACT

The invention relates to a housing (10) for an electronic device of the type that comprises a main part or body (24) with an opening, and a movable part or cover (28) which forms a blocking cover of the opening between an assembled position on the body (24) and a disassembled position of the type in which the cover (28) comprises at least a hook (40) which is retained in assembled position by a retractable catch (42) which is installed movably in guiding means (44) of the housing (10) between a locked position and an unlocked position, characterized in that the retractable catch (42) belongs to a locking element (46) whose translation is guided along a longitudinal direction roughly orthogonal to the direction in which the hook (40) extends and which comprises a longitudinal stem portion which co-operates with the hook (40) and in that the housing (10) comprises retaining means for retaining the stem portion in locked position.

The invention proposes a housing for an electronic device which comprises a body with an opening and a movable part which forms a blocking cover of the opening.

The invention more particularly proposes a housing for an electronic device of the type which comprises a main part or body with an opening and a movable part forming the blocking cover of the opening between an assembled position on the housing and a disassembled position.

The invention also relates to an electronic device formed by such a housing.

There are numerous housings of this type such as the housings of mobile telephones of the GSM type, or razors.

Indeed, the body of such housings may have an opening which permits access to a compartment such as a battery compartment.

The cover may also consist of a wall forming a complete face of the housing.

For a mobile telephone this wall may be the front wall or main wall of the telephone, which is passed through by keys of a keypad and by a display screen.

In the two cases the user of the electronic device may be led to open the housing, that is to say, to separate the cover from the body.

In the former case the opening may permit to change the batteries. It may also permit to add or remove an accessory for adapting the electronic device.

In the latter case the opening may permit to change a cover, to replace it with another cover which has a different esthetic effect, such as color. The replacing operation of the cover of the housing permits to personalize the housing; it is also called customization.

In known manner, the cover and body are assembled by screwing them together. Such assembling poses a tool problem.

Indeed, each time the user wishes to open the housing, for example, for changing the batteries, he has to have an adapted screw driver.

The screw is put in a complementary thread. Since the housings are generally made of plastic, and to ensure a sufficient resistance it is necessary for the thread to be realized in a metallic insert which is placed in one of the parts of the housing.

The arrangement of the inserts realized inside the housing diminishes the volume of the latter.

Such solution is expensive, because assembling the housing calls forth two additional elements which are the screw and the insert.

The times of screwing and unscrewing are important, which increases the time necessary for assembling the housing when the electronic device is manufactured, but also the time of opening and closing of the housing. Moreover, there is a risk of the screws being lost.

Another solution consists of the elastic fitting of the lip of a hook of one part of the housing in a complementary form in a recess in the other part of the housing. Although assembling the body and the cover is simple and easy to realize, this solution does not permit easy disassembling of the body and the cover without a risk of deteriorating one of the parts of the housing.

To permit the release of the hook from the recess it is known that for each pair of elements one of them is to be movable.

For example, when the hook is realized integral with a free edge of a wall of one of the parts of the housing, the deformation in a sense opposite to the direction in which the lip of the hook engages in a complementary form the recess of the other part, permits the release of the lip.

However, the wall supporting the hook is to be sufficiently resistant to satisfy the functional requirements of the housing and sufficiently flexible to permit its deformation which permits the lip to be released. These two conditions are hard to satisfy. Thus, it frequently happens that after various cycles of assembling/disassembling the housing, the wall that carries the hook breaks down. This breaking is mainly due to exerting force to deform the hook, which force is greater than the minimum force required.

Moreover, the deformation of the wall that carries the hook needs free space inside the housing. This augments the dimensions and cumbersomeness of the housing.

According to a variant, it is the complementary form of the recess forming the catch which is movable between a locking position, in which it retains the hook to keep the body and cover in assembled position, and an unlocked position, in which it releases the hook to permit the cover to be disassembled.

When the catch is realized in one piece with the wall with which it is integral, this solution has the same drawback as those presented earlier.

The catch may also consist of an element relative to a part of the housing. This solution is hard to realize, because it calls forth a complex installing which permits the assembling and the guiding of the element relative to the associated part of the housing.

In order to provide a solution to this problem, the invention proposes a housing for an electronic device of the type comprising a main part or body with an opening and a movable part which forms the blocking cover of the opening between an assembled position on the body and a disassembled position, of the type in which the cover comprises at least one hook which extends into the inside of the body and which is retained in assembled position by a retractable catch which is movably installed in guiding means for the housing, between a locked position in which it retains the hook to keep the body and cover together and an unlocked position in which it releases the hook to permit the disassembling of the cover, characterized in that the retractable catch belongs to a locking element whose translation is guided in a roughly longitudinal direction orthogonal to the direction in which the hook extends and which has a longitudinal stem portion which co-operates with the hook, and in that the housing comprises retaining means for retaining the stem portion in locked position.

According to other characteristics of the invention:

the cover comprises at least two hooks which are retained in assembled position by at least two associated stem portions which belong to a locking element that locks the two hooks in common;

the two hooks are substantially longitudinally aligned and the common locking element is a stem whose two sections form said stem portions of which each one-cooperates with an associated hook;

the housing comprises at least two hooks which are opposite each other in transverse direction, and the locking element is a pin in the form of a U whose two longitudinal parallel branches carry two respective stem portions of which each one-cooperates with an associated hook;

in locked position an intermediate transverse branch of the pin in the form of a U, which branch forms a catch element, is accommodated in a first chamber provided in a wall of the housing;

the retaining means comprise a boss which extends to inside the first chamber and which, in locked position, extends relative to the intermediate branch so as to immobilize the locking element at least in one sense in the longitudinal direction;

the retaining means comprise a blocking shutter which is installed movably in a wall of the housing between a blocking position and a release position so as to either or not release the movement of the intermediate branch of the locking element at least in one sense of the longitudinal direction;

the retaining means comprise at least a second chamber in which at least a hole is provided which accommodates in a tight arrangement at least one free end of the locking element so as to stop the latter in a longitudinal translation;

the locking element comprises a retaining area, such as a section variation, which in locked position co-operates with a complementary element, such as a pin;

the locking element comprises a catch which is adjacent to said stem portion and which, in unlocked position, is opposite the hook associated to said stem portion and permits its release to separate the body and the cover;

the hook comprises a connecting part of which one end is flush with the cover and of which the other end forms a lip which, in assembled position, co-operates with the locking element;

the connecting part of the hook can elastically be deformed in a transverse direction substantially perpendicular to the longitudinal direction of the stem portion, so that the lip is retracted during the assembling and is then retained by the stem portion when the movable screen is in locked position;

the free end of the hook follows a ramp which co-operates with the periphery of the catch during the assembling to cause the hook to be retracted via elastic deformation;

the housing is roughly a parallelepiped and at least two hooks extend to the proximity of the two opposite internal longitudinal guiding walls of the housing;

the housing comprises slewing means which are shifted relative to at least one hook and which permit to slew the housing and the cover, so that when the retractable catch is in unlocked position, the opening of the housing is obtained by pivoting the cover according to the axle of the slewing means.

These and other aspects of the invention are apparent from and will be elucidated, by way of non-limitative example, with reference to the embodiment(s) described hereinafter.

### IN THE DRAWINGS

FIG. 1 is a perspective view of a housing for an electronic device realized according to a first embodiment of the invention;

FIG. 2 is a cross-sectional view through the housing for the electronic device along line IV-IV shown in the previous Figure;

FIG. 3 is a perspective and detailed view of a hook for assembling the housing;

FIG. 4 is a transverse cross-sectional view through the housing for the electronic device along line IV-IV shown in FIG. 2;

FIG. 5 is a perspective view of a housing for the electronic device realized in a second preferred embodiment of the invention;

FIG. 6 is a longitudinal cross-sectional view through the housing for the electronic device along line VI-VI represented in the previous Figure;

FIG. 7 is a partial longitudinal cross-sectional view through the front part of the housing according to a variant of an embodiment of the invention, comprising a blocking shutter represented in blocking position;

FIG. 8 is a view similar to that represented in the previous Figure, the blocking shutter being represented in retracted position;

FIG. 9 is a longitudinal cross-sectional view through an example of embodiment of retaining means of a locking element of the housing;

FIG. 10 is a transverse cross-sectional view through the housing along the line X-X of FIG. 5 during the assembling of two parts forming the housing;

FIG. 11 is a similar view to that represented in the previous Figure with an assembled housing;

FIG. 12 is a partial large-scale cross-sectional view along a horizontal plane in which the locking element is represented in locked position according to a variant of the invention;

FIG. 13 is a similar view to that represented in the previous Figure, the locking element being represented in unlocked position.

In the following of the description, identical or like elements will be designated by the same reference characters.

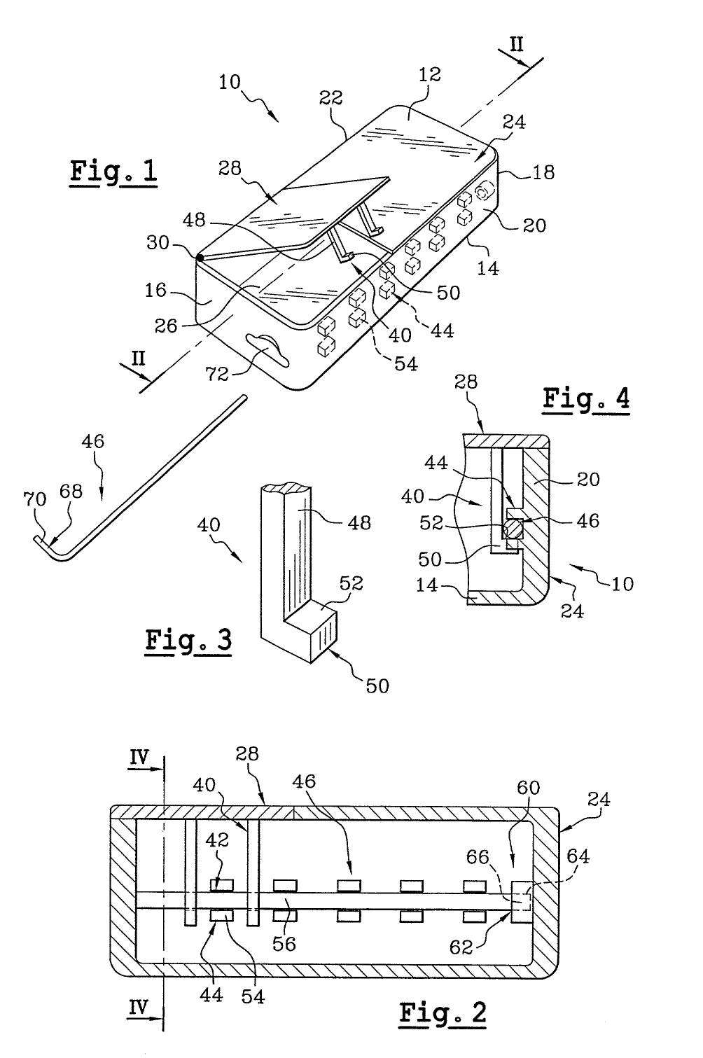

In the following of the description will be used by way of non-limitative example a longitudinal orientation and a transverse orientation along the lines II-II and IV-IV represented in the FIGS. 1 and 2, respectively. An upper/lower orientation will also be used notably in accordance with FIG. 1.

FIG. 1 represents a housing 10 intended to accommodate an electronic device which is not shown.

The housing 10 is here a parallelepiped which represents according to FIG. 1 an upper wall 12 and a lower wall 14 which stretch out in horizontal planes, as well as a front wall 16, a back wall 18 and two side walls 20 and 22 which are roughly vertical.

The housing 10 comprises a main part or body 24 with an opening 26 realized in the upper wall 12. The opening 26 permits the access to a cavity which accommodates, for example, supply batteries or a modular element such as a memory extension of the electronic device.

The housing 10 also comprises a movable part 28, which forms a blocking cover of the opening 26. The cover 28 is movable between an assembled position on the body 24 and a disassembled or open position represented in FIG. 1.

Here the cover 28 is slewable relative to the body 24 via a slewing 30 in a longitudinal direction. The slewing 30 may be a hinge of known type which makes the free upper edge of the side wall 22 of the body 24 integral with the free edge of the cover 28.

According to a variant, the slewing 30 consists of complementary means of the body 24 and of the cover 28 which co-operate when the cover 28 is in assembled position, and which are separated when the cover 28 is in open position, so as to permit them to be separated completely.

In order to keep or lock the housing 10 in assembled position, the cover 28 comprises hooks 40 which, in assembled position, stretch out to inside the body 24 and co-operate with retractable catches 42, represented notably in FIG. 2.

The housing 10 here comprises two hooks 40 which are longitudinally aligned and which are arranged near to the free side edge of the cover 28 which is opposite to the hinge 30.

Each hook 40 comprises a connection stem 48 of which one upper end is integral with the cover 28 and of which the other lower end forms a lip 50.

The lip 50, represented in detail and in perspective view in FIG. 3, comprises a retaining face 52, which is substantially horizontal and oriented perpendicularly to the overall direction of the hook 40.

The retractable catches 42 are installed as movable parts between a locked position, represented in FIGS. 2 and 4, in which they retain the hooks 40, and an unlocked position, represented in FIG. 1, in which they release the hooks to permit the cover 28 to be disassembled.

The retractable catches 42 are guided in guiding means 44 of the housing 10.

According to the invention the retractable catches 42 belong to a locking element 46.

The locking element 46 is here guided in translation according to a roughly longitudinal direction which is orthogonal to the direction in which the hooks 40 stretch out and which comprises portions 56 of the longitudinal stem which co-operate with the hooks 40. In accordance with FIG. 4, the transverse section of the stem portions 56 is circular. According to a variant the transverse section 56 may be different, notably square.

The guiding means 44 comprise rib portions 54 which permit to keep the retractable catches 42 up and down. The rib portions 54 are arranged in longitudinal direction and shifted longitudinally relative to the catches 42, according to FIG. 2, so as to permit retractable catches 42, notably their lips 50, to pass through during their movements between the assembled position and the open position of the cover 28.

In locked position, represented in FIG. 2, the retractable catches 42 retain the hooks 40 by co-operating with the retaining faces 52 of the lips 50.

In unlocked position, represented in FIG. 1, the retractable catches 42 release the hooks 40 to permit the cover 28 to be removed. Here the locking element 46 is outside the housing 10.

As the housing 10 comprises various hooks 40, the stem portions 56 associated to the hooks 40 belong to the locking element 46 which is advantageously used in common by the two hooks 40.

The housing 10 also includes means 60 for retaining the locking element 46 in locked position.

The retaining means 60 comprise a chamber 62 in which a hole 64 is made which receives by force the free back end 66 of the locking element 46. Thus, when the free back end 66 enters the hole 64, the longitudinal translation of the locking element 46 is stopped in the locked position.

The back end 68 of the locking element 46 is curved in a transverse direction so as to form a grip element 70.

The front wall 16 of the body 24 has an opening 72 which allows the front part of the locking element 46 to pass through and which also forms a chamber for the grip element 70 when the locking element 46 is in locked position.

To close the housing 10, the cover 28 is put in assembled position, after which the locking element 46 longitudinally falls into the opening 72. It is guided by the guiding means 44 formed by rib portions 54 which permit to guide the locking element 46 upwards and downwards, and also by the connecting portions of the hooks 40 and the sidewall 20 of the body 14 which transversely guide the locking element 46.

The longitudinal arrangement runs on until the free back end 66 of the locking element 46 falls into the hole 64, that is to say, until the locking element 46 is in locked position.

The locking element 46 thus retains the faces 52 of the hooks 40.

The locking element 46 is integral with the housing 10 and obstructs the opening of the cover 28.

To open the housing 10, the user pulls the grip element 70 longitudinally to the outside of the housing. The free back end 66 of the locking element 46 is freed from the hole 64. When the grip element 70 is outside the housing 10, the hooks 40 are released and the cover 28 can be opened freely to its disassembled position.

A housing 10 according to the invention is highly advantageous. Actually, the disassembling of the cover 28 is realized without specific tools, because the user can easily manoeuver the grip element 70 with the end of one of his fingers.

Moreover, the disassembling of the cover 28 does not need any deformation of a part of the housing, which eliminates any fatigue of the material the housing consists of. Thus, the assembling/disassembling rate of the housing 10 may be realized a great many times without a risk of deteriorating an element that forms it.

According to a second preferred embodiment shown in FIG. 5, the invention proposes that the body 24 and the cover 28 consist of a first, lower shell half and a second, upper shell half, respectively.

The second shell half 28 comprises an upper wall 74 opposite the lower wall 14 of the first shell half 24. The second shell half 28 also comprises in similar fashion to the first shell half 24 a front wall 76, a back wall 78 as well as two sidewalls 80 and 82.

Such type of housing 10 is notably used for mobile telephones. The body 24 accommodates the electronic device and the cover 28 thus forms the main face or front of the telephone.

The user of the telephone may be led to disassemble the housing 10 notably for changing the cover 28 so as to personalize his device. In practice, the user possesses various different covers 28 which he puts on the body 24 as he wants to or needs to.

The invention permits to assemble and disassemble the second shell half 28 in a simple, fast and frequent manner without a risk of deteriorating the housing 10.

To avoid the shell halves 26 and 28 gliding over each other in a horizontal plane when the housing 10 is assembled, a rib 84 and a complementary opening 86 are realized on the free edges of the sidewalls 20, 22, 80, 82 at the front 16, 76 and back 18, 78 of the first and second shell halves 24 and 28, respectively.

The housing 10 comprises two longitudinal rows of hooks 40 which are transversely opposite each other and which are here situated close to the sidewalls 80 and 82 of the second shell half 28.

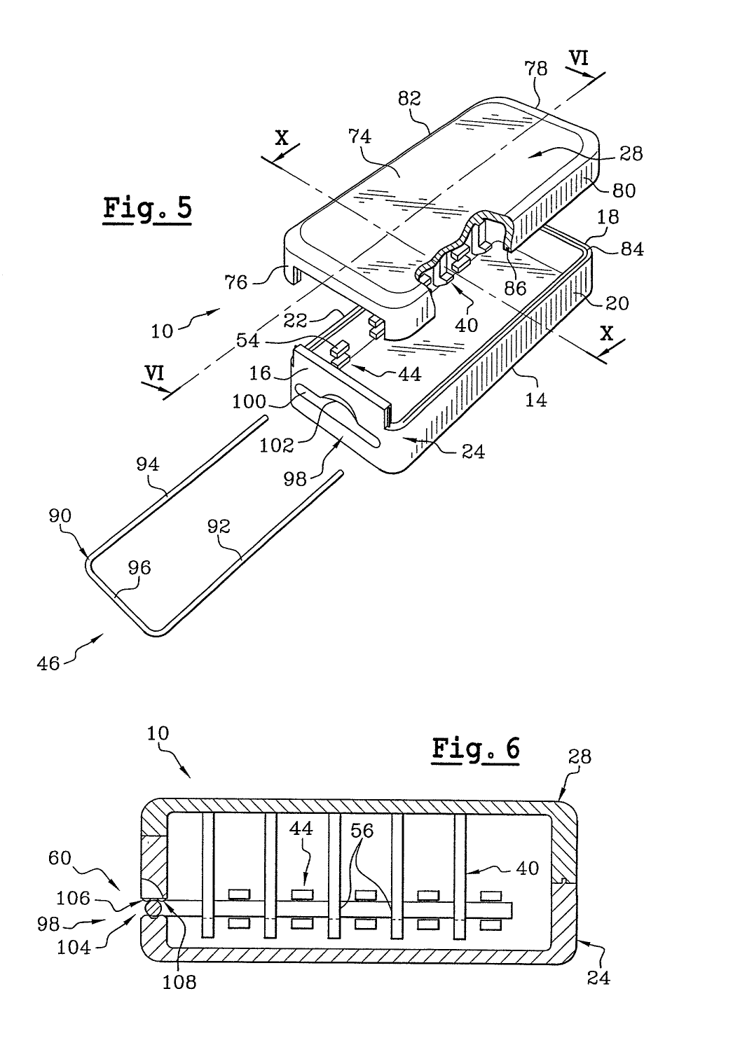

To facilitate the assembling and disassembling of the housing 10, the locking element 46 is a pin 90 in the form of a U whose two longitudinal parallel back branches 92 and 94 comprise stem portions 56 (FIGS. 2 and 6) which, in assembled position of the second shell half 28, co-operate with the retaining faces 52 of the associated hooks 40.

The pin 90 also comprises an intermediate transverse branch 96 which forms a gripping element.

The pin 90 is advantageously realized by folding a metallic wire of circular section.

In locked position, the intermediate transverse branch 96 ends in a chamber 98 formed in the front wall 16 of the first shell half 24.

The chamber 98 has an oblong opening 100 for transverse orientation, which permits to accommodate the intermediate transverse branch 96. The height of the oblong opening 100 is substantially equal to the diameter of the branch 96.

A notch 102 realized in the front face of the front wall 16 comes out into the opening 100. The notch 102 permits the user to free the transverse branch 96 from the housing 98 when the pin is in locked position, in accordance with FIG. 6.

Here the retaining means 60 for the locking element 46 in locked position are realized in the housing 98.

The retaining means 60 comprise bosses 104 which extend to the interior of the housing 98.

There are four bosses 104 here. Each upper and lower face of the housing 98 comprises two bosses which are each arranged opposite to a boss associated to the other face, and arranged at the front and back of the intermediate transverse branch 96 when the locking element 46 is in locked position. Thus, the retaining means 60 comprise a front pair 106 and a back pair 108 of bosses 104.

The front and back pairs 106 and 108 permit to reduce the headroom inside the housing 98 so as to immobilize the locking element 46 each in a longitudinal direction.

Passing the transverse branch 96 between the bosses 104 of the front pair 106 causes the bosses to be elastically deformed.

The bosses 104 of the back pair 108 may be similar to the bosses of the front pair 106.

Advantageously, their height is greater than the height of the bosses of the front pair 106, so that stops are formed for blocking the backward longitudinal translation of the locking element, to prevent the transverse branch 96 penetrating the inside of the housing 10.

When the locking element 46 is in locked position, that is to say, when the branch 96 is located between the front pair of bosses 106 and back pair of bosses 108, it is necessary to exert sufficient power in axial direction towards the front to again elastically deform the two bosses of the front pair 106 and release the locking element 46.

According to a variant, the back pair 108, which forms stops, is a sidewall (not shown) which partly closes the housing 98 at the back. In this case, the sidewall extends opposite to the transverse branch 96 so as to let the longitudinal branches 92 and 94 free to pass to the inside of the housing 10.

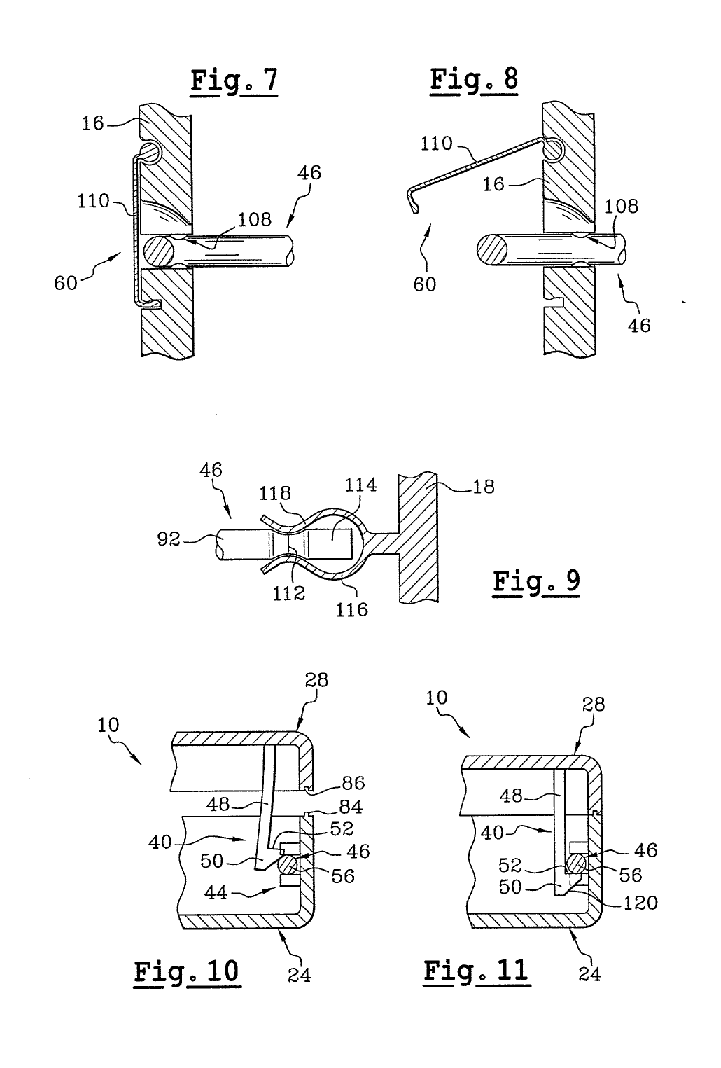

According to another variant, the front pair 106 is replaced by a movable blocking shutter 110 represented in FIGS. 7 and 8.

The blocking shutter 110 is thus installed slewably relative to the front wall 16 between a blocking position represented in FIG. 7, in which it immobilizes the locking element 46 in the longitudinal direction to the front, and a retracted position represented in FIG. 8.

The shutter 110 may be molded in one piece with a housing component 10 with its slewing hinge in the form of a molded film.

In accordance with FIG. 9 the retaining means 60 may also comprise a retaining area 112 which is realized on a longitudinal branch, for example, the longitudinal branch 92, close to the free end 114 of the longitudinal back branch and which co-operate in locked position with a complementary element 116 of the housing 10.

Here the retaining area 112 consists of a variation of a cross-section through the longitudinal branch 92, which co-operates with complementary clip 116 fixed to the back wall 18 of the first shell half 24. The clip 116 consists of two strips 118 which are elastically deformable and whose front free ends are complementarily shaped in accordance with the retaining area 112 of the longitudinal branch 92.

Thus, when the locking element 46 is longitudinally arranged in the housing 10 up to its locked position, its free end 114 causes the two strips 118 to be widened, which again close their ends when co-operating with the retaining area 112. The strips 118 thus immobilize the locking element in the two senses of the longitudinal direction.

To free the retaining area 112 from the complementary clip 116, it is necessary to exert sufficient pressure in axial direction and oriented to the front, to again widen the two strips 118 and set the locking element 46 free.

The locking of the housing assembly 10 realized according to the second embodiment may be similar to that of the housing 10 realized according to the first embodiment, that is to say, that the second shell half 28 is put together with the first shell half 24, after which the locking pin 90 is put into the housing 10 via the chamber 98 and guided in the guiding means 44 to lock the assembly.

Preferably, the operations are reversed. Indeed, the invention proposes that the locking pin 90 is put into the housing 10 up to its locking position. Then, the first and second shell halves 24 and 28 are positioned opposite to each other. They are brought together in a vertical direction until the lips 50 of the hooks 40 enter into contact with the associated stem portions 56 of the locking pin 90.

The connecting part 48 of each hook is then elastically deformed in a direction substantially perpendicular to the longitudinal direction of the corresponding stem portion 56. Thus the corresponding lip transversely folds away in conformity with FIG. 10.

The connecting part 48 thus behaves as a beam subjected to bending in a direction substantially perpendicular to its general axis.

To facilitate the deformation of the connecting part 48 and the folding away of the lip 50 of the hook 40, the lower free end of the hook 40 is advantageously in conformity with a ramp 120.

Thus, when the ramp 120 co-operates with the periphery of the stem portion 56 of the pin 90, the lip 50 folds away and permits the two shell halves 24 and 28 to come close together.

The elasticity of the connecting part 48 permits the hooks 40 to return to a substantially vertical position when the retaining face 52 of the lip 50 is on a level with the lower part of the stem portion 56 (see FIG. 11).

The length of the hooks 40 as well as the dimensions of the sidewalls 20, 22, 80 and 82 and the position of the pin 90 relative to the upper edge of the sidewalls 20 and 22 of the first shell half 24 are determined so that, when the two shell halves 24 and 28 are put together, there is minimum play between the retaining face 52 of the hooks 40 and the lower part of the stem portions 56.

Thus, the assembly is locked by deformation and elastic return of the hooks 40 also called elastic joining or clipping.

The housing 10 is thus disassembled in that the pin 90 is extracted from the housing 10 so as to set the retaining faces 52 of the hooks 40 free and permit the two shell halves 24 and 28 to be separated in a vertical direction. Extracting the pin 90 can be done by a tensile stress exerted on the transverse branch 96 in the longitudinal direction to the front of the housing 10.

Thus, the assembly, the locking of the assembly and the disassembling of the housing 10 is realized in a simple and rapid manner. Moreover, this may be realized many times without a risk of deteriorating one of the elements of the housing 10.

Even if the longitudinal branches 92 and 94 are not perfectly rectilinear, notably in the horizontal plane, it is possible to insert the pin 90 into the housing 10 up to its locked position, because the transverse guiding is only realized by the connecting parts 48 after the housing 10 is assembled and locked.

According to the invention it is possible to increase the number of hooks 40 of the second shell half 28 without modifying the pin 90.

The increase of the number of hooks 40 permits the reduction of their dimensions while the same resistance of the assembly is retained. The reduction of the dimensions of the hooks 40 thus permits to reduce their cumbersomeness and, in consequence, offers a larger useful volume inside the housing 10.

According to the invention the longitudinal positioning of the hooks 40 need not be done with great precision. Indeed, the retractable catches 42 with which they cooperate here consist of a longitudinal locking element 46 which extends over substantially the entire length of the housing 10.

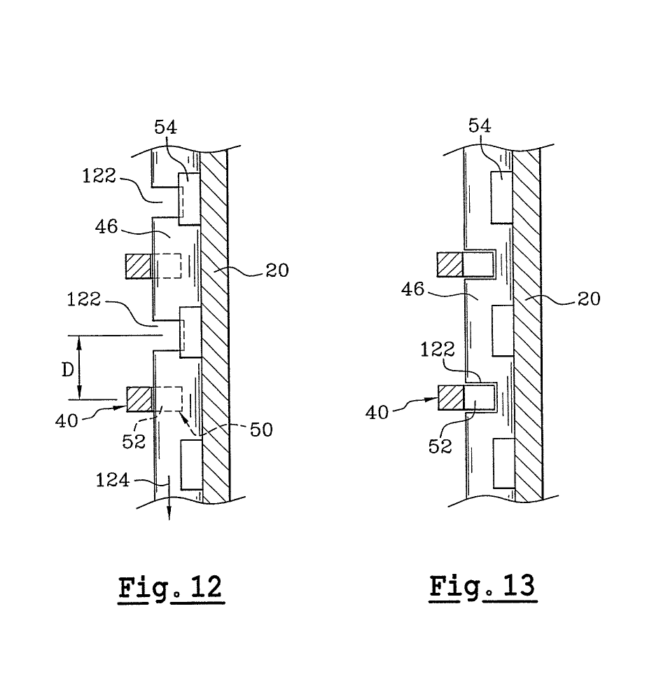

According to a variant represented in FIGS. 12 and 13, the locking element 46 comprises notches 122 whose dimensions are substantially greater than those of the retaining face 52 of the associated lip 50.

The notches 122 are shifted in longitudinal direction by a distance D of the retaining face 52 of the associated hook of the housing 10.

The assembly and the locking are realized in conformity with the operations described earlier.

Disassembling the housing 10 then consists of the translation of the distance D of the locking element 46 in the sense of the longitudinal direction represented by the arrow 124, so that the notches 122 are positioned facing the retaining face 52 by thus permitting the hook 40 to be released and the housing 10 to be disassembled.

Thus, the unlocking operation consists of a minor longitudinal displacement of the pin 90 which is not extracted from the housing 10. This considerably reduces the risk of losing and/or damaging the pin 90 when the housing 10 is disassembled and when the second shell half 28 is changed.

The above description is realized by way of non-limitative example. Indeed, the mechanical reverse such as the reverse between the upper part and the lower part can be envisaged without leaving the scope of the protected invention. That is to say, that the hooks may be realized with the body 24 and that the fold-away catches can be formed on the cover 28 of the housing 10.

1. A housing (10) for an electronic device of the type that comprises a main part or body (24) with an opening (26), and a part (26) forming the blocking cover of the opening (26), movable between an assembled position on the body (24) and a disassembled position, of the type in which the cover (28) comprises at least one hook (40) which extends into the inside of the body (24) and which is retained in assembled position by a fold-away catch (42) which is installed movably in guiding means (44) of the housing (10) between a locked position in which it retains the hook (40) to keep the body (24) and the cover (28) in assembled position and an unlocked position in which it releases the hook (40) to permit the cover (28) to be disassembled, characterized in that the fold-away catch (42) belongs to a locking element (46) whose translation is guided in a longitudinal direction roughly orthogonal to the direction in which the hook (40) extends and which comprises a longitudinal stem portion (56) which co-operates with the hook (40), and in that the housing (10) comprises retaining means (60) for retaining the stem portion (56) in locked position.

2. A housing (10) of an electronic device as claimed in the preceding claim, characterized in that the cover (28) comprises at least two hooks (40) which are retained in assembled position by at least two associated stem portions (56) which belong to a locking element (46) shared by the two hooks (40).

3. A housing (10) of an electronic device as claimed in the preceding claim, characterized in that the two hooks (40) are substantially longitudinally aligned and in that the shared locking element (46) is a stem whose two parts form said stem portions (56) of which each one co-operates with an associated hook (40).

4. A housing (10) of an electronic device as claimed in one of the claims 2 or 3, characterized in that it comprises at least two hooks (40) which are transversely opposite each other and in that the locking element (46) is a pin (90) in the form of a U whose two parallel longitudinal branches (92, 94) carry two stem portions (56) of which each one co-operates with an associated hook (40).

5. A housing (10) of an electronic device as claimed in the preceding claim, characterized in that in locked position the intermediate transverse branch (96) of the pin (90) in the form of a U, which forms a gripping element, is accommodated in a first chamber (98) formed in a wall of the housing (10).

6. A housing (10) of an electronic device as claimed in the preceding claim, characterized in that the retaining means (60) comprise a boss (104) which extends into the first chamber (98) and which, in locked position, extends relative to the intermediate branch (96) so as to immobilize the locking element (46) at least in one sense of the longitudinal direction.

7. A housing (10) of an electronic device as claimed in one of the claims 5 or 6, characterized in that the retaining means (60) comprise a blocking shutter (110) which is installed movably in a wall of the housing (10) between a blocking position and a retracted position so as to either or not prevent the movement of the intermediate branch of the locking element (46) at least in one sense of the longitudinal direction.

8. A housing (10) of an electronic device as claimed in any one of the preceding claims, characterized in that the retaining means (60) comprise at least a second chamber (62) in which at least one hole (64) is realized which accommodates at least one free end (66) of the locking element (46) so as to stop the latter in longitudinal translation.

9. A housing (10) of an electronic device as claimed in any one of the preceding claims, characterized in that the locking element (46) comprises a retaining area (112) as well as a variation of section which, in locked position, co-operates with a complementary element (116) such as a clip.

10. An electronic device formed by a housing as claimed in one of the claims 1 to 9.
